(19) United States
(12) Patent Application Publication
(10) Pub. No.: US 2013/0278215 A1
(43) Pub. Date: Oct. 24, 2013

(54) Case For Portable Electronic Device With Integral Detachable Power Converter For Battery Charging

(71) Applicants: lGregory Dea, Clarence, NY (US); Matthew Battista, Williamsville, NY (US); Brett Bennett, Williamsville, NY (US); Jeffrey Deal, Clarence, NY (US)

(72) Inventors: lGregory Dea, Clarence, NY (US); Matthew Battista, Williamsville, NY (US); Brett Bennett, Williamsville, NY (US); Jeffrey Deal, Clarence, NY (US)

(21) Appl. No.: 13/561,996

(22) Filed: Jul. 30, 2012

Related U.S. Application Data
(60) Provisional application No. 61/636,670, filed on Apr. 22, 2012.

(51) Int. Cl. H02J 7/02

(52) U.S. Cl. 320/111

(57) ABSTRACT

An auxiliary device case for portable electronic devices provides physical protection from abrasion and mishandling. The device case includes an integral power converter module with small form factor. The power converter module is provided to power and recharge the internal batteries of the portable electronic device, and is stored within the case when not in use. The power converter module is removable from the case for connection to a wall power receptacle and is connected to the case by means of a retractable cord. The power converter module may include retractable blades and a hinged cord attachment to minimize the overall volume when stored within the case.

### CROSS-REFERENCE TO RELATED APPLICATIONS

This application claims priority to and the benefit under 35 U.S.C. 119(e) of U.S. Provisional Application No. 61/636,670 filed on Apr. 22, 2012. The entire contents of said Provisional Application No. 61/636,670 are hereby incorporated by this reference as if fully set forth herein.

### BACKGROUND

1. Field

The present invention relates to accessories for portable electronic devices, and more particularly relates to power converter apparatus for charging the batteries of portable electronic devices. The invention further relates to protective cases for portable electronic devices.

2. Description of the Prior Art

By way of background, portable electronic devices have become ubiquitous and now find wide usage by almost all individuals, not only in the developed world but also in emerging nations. These devices include cellular telephones, personal digital assistants, music players, portable computers, and so on. Almost without exception, portable electronic devices are powered by electrochemical cells (batteries), with the majority of these being secondary cells that are rechargeable. Such devices therefore need a suitable source of electrical energy to periodically recharge the batteries. The recharging energy is typically provided from a utility mains source such as 120 Vac/60 Hz power in the United States or 230 Vac/50 Hz power on the European continent. Electronic circuitry is used to convert the high ac voltage to a low dc voltage suitable for recharging the batteries in the device. For the many devices that do not integrate this recharging circuitry into the device, the user must have access to a separate charging device and interconnecting cable that is cumbersome to carry.

The requirement for providing a reliable source of power and conveniently recharging the batteries of portable electronic devices has given rise to a number of different proposed solutions. One approach utilizes an inductive coupling charger system wherein a first component of the charger generates an alternating current magnetic field and a second component of the charger is fitted to the device to be charged. Mutual magnetic coupling between the two components allows the transfer of energy to charge the device batteries via the magnetic field. This type of system is described in U.S. Pat. Nos. 7,906,936 of Azancot et al. and 8,169,185 of Partovi et al. The '936 patent discloses an implementation to inductively transfer only energy for battery charging while the '185 patent discloses an implementation for transmitting not only energy but also information. While this split-component approach works to minimize the volume of hardware that must be added to the portable electronic device to implement the inductive interface, it hinders device mobility because the device must either be moved to a location where the complementary charging equipment is available, or the complementary equipment must be carried with the device.

A second approach to providing a reliable source of power and recharging energy for portable electronic devices is to utilize a backup or secondary battery pack. U.S. Pat. No. 7,619,388 of Nana discloses such a back-up battery pack that comprises batteries and an integral battery charging circuit, as well as a retractable cord and plug to interface electrical energy to the portable electronic device. The connection to an ac power mains receptacle is made by means of blades that fold into the battery pack housing when not in use. Another example of this approach is disclosed in U.S. Patent Application Publication No. 2006/0267547 of Godovich. The '547 publication discloses a replacement battery pack that comprises an enclosure with internal batteries, circuitry and connectors to convey electrical energy from the internal batteries to a portable electronic device. One disclosed embodiment includes an integral ac-to-dc converter and a retractable ac power cord so that the internal batteries may be recharged when an ac mains receptacle is convenient. In both the '388 patent and the '547 publication, the battery packs may be physically attached to the portable electronic device to minimize the number of loose pieces that must be carried. However, the battery pack is large, and in the case of the '388 patent, is equal to or greater than the device that is being powered. This approach compromises the convenience of having a small portable device that can be carried in a pocket or purse. Similar shortcomings are found in U.S. Patent Application Publication No. 2012/0049800 of Johnson et al. and U.S. Pat. Nos. 7,151,356 of Chen and 6,421,235 of Ditzik. Each of these documents teaches a battery pack that combines batteries, power conversion circuitry and a means of connection to ac mains power by a cord or plug blades that are integral to the device enclosure. Again, each battery pack provides a power source and recharging system for a portable electronic device, but encumbers the user with additional pieces that must be carried and accounted for.

A third approach to powering and recharging portable electronic devices, which is perhaps the most commonly practiced technique, is disclosed in U.S. Pat. Nos. 7,859,133 of Youn et al. and 7,563,130 of Farrar et al., and in U.S. Patent Application Publication No. 2012/0098492 of Sulem et al. Each of these documents discloses a module or group of assemblies, one of which implements ac-to-dc power conversion circuitry. In each disclosed design, the module containing the power conversion circuitry is integral with the blades of the ac mains plug, and the low voltage dc interface to the portable electronic device is made by a separate cable. The '133 patent discloses a power converter module wherein a loose rechargeable cell may be inserted into the module to effect recharging. The '130 patent discloses a number of power converter embodiments that address the management of the dc power cord both during charging and when the power converter is stored. The '492 publication teaches a power converter module of small form factor wherein the blades of the ac mains plug may be retracted into the envelope of the module to minimize the volume when the module is not in use. In each of the disclosed power converter modules, the user must carry one or more items with the personal electronic device to ensure that the batteries can be recharged when necessary.

In an apparent effort to address the above shortcoming, a recently announced product known as the “JuiceTank” integrates a power converter into a cellular telephone case. As such, a user does not need to carry both devices separately. However, a disadvantage of this approach is that the ac power plug blades are mounted to case, which means that the entire telephone sits on the ac wall socket during charging. Due to this positioning, the functions of the telephone cannot be conveniently utilized until the device is unplugged.

### SUMMARY

The foregoing problems are solved and an advance in the art is provided by a novel accessory protective case for portable electronic devices. The device case includes a conformal covering case shell configured to encompass all or a portion of a portable electronic device. In one aspect of the invention, the device case includes a small power conversion module that is detachable from the device case during use and which may be stored in a module holder in the rear of the device case when not in use. In another aspect of the invention, the device case includes a power cord reel with an electrical slip ring so that the dc power cord connecting the power conversion module to the case may be quickly and easily refracted into the case. In yet another aspect of the invention, a pair of ac power mains plug blades on the power conversion module can rotate and retract into the housing envelope of the conversion module when not in use, thereby reducing the conversion module thickness. In yet another aspect of the invention, the power conversion module has a hinged connection for the dc power cord, so that the cord may be rotated relative to the power conversion housing when transitioning between storage and deployment to minimize the thickness of the power conversion module. In yet another aspect of the invention, the connection between the case and the portable electronic device through which the battery charging current flows may be temporarily disconnected without removing the case in order to connect the electronic device to other equipment.

It is therefore an object of the invention to provide a protective case for a portable electronic device that includes a small power conversion module and a retractable dc power cord with a low-profile form factor.

A further object of the invention is to provide a protective case for a portable electronic device case that includes a detachable power conversion module that may be connected to a wall receptacle for ac mains power and allow the portable electronic device to be manipulated and used while connected to the wall receptacle for powering or internal battery recharging. The device case may be fitted with an integral cord reel or spool equipped with an electrical slip ring to permit extension and refraction of the dc power cord by means of reel rotation.

A still further object of the invention is to provide a power conversion module with a unique implementation of ac power mains plug blades that may rotate and retract into the module case when not in use in order to minimize the power conversion module case thickness.

A still further object of the invention is to provide a power conversion module with a hinged connection for a captive cord, so that the cord may be rotated about the power conversion module case when transitioning between storage and deployment to minimize the power conversion module thickness.

### BRIEF DESCRIPTION OF THE DRAWINGS

The foregoing and other features and advantages will be apparent from the following more particular description of example embodiments, as illustrated in the accompanying Drawings, in which:

FIG. 1 is a plan view of the rear of an exemplary embodiment of the present invention when attached to a representative portable electronic device;

FIG. 2 is an elevation end view of the narrow end of an exemplary embodiment of the present invention when attached to a representative portable electronic device;

FIG. 3 is an elevation side view of the wide side of an exemplary embodiment of the present invention when attached to a representative portable electronic device;

FIG. 4 is a plan view of the rear of an exemplary embodiment of the present invention with the interface connector to the portable electronic device un-mated;

FIG. 5 is a plan view of the rear of an exemplary embodiment of the present invention with the power conversion module removed from a case cavity for insertion into an ac mains wall receptacle, and with the dc power cord unfolded and the ac power mains plug blades are extended;

FIG. 6 is an elevation end view of the narrow end of an exemplary embodiment of the present invention illustrating a case cavity that may be used to carry the power conversion module;

FIG. 7 is an elevation end view of the power conversion module with the dc power cord folded into position for stowing within the case;

FIG. 8 is a plan view of the power conversion module configured for stowing in the case, with the dc power cord folded beneath the module and the ac mains plug blades refracted;

FIG. 9 is an elevation end view of the power conversion module with the ac mains plug blades refracted;

FIG. 10 is an elevation end view of the power conversion module with the dc power cord unfolded into position for deployment;

FIG. 11 is a plan view of the power conversion module configured for insertion into an ac mains wall receptacle, with the dc power cord unfolded and the ac mains plug blades extended;

FIG. 12 is an elevation end view of the power conversion module with the ac mains plug blades extended, rotated and fixed into position; and

FIG. 13 is an elevation side view of the power conversion module with the ac mains plug blades extended and components of the ac-to-dc power conversion circuitry represented.

### DETAILED DESCRIPTION OF EXAMPLE EMBODIMENTS

### Introduction

An exemplary portable electronic device case with integral power conversion module for providing power and charging the batteries of a portable electronic device will now be described, together with design aspects for a power conversion module with minimum volume and maximum ease of use. The device case is usable as an accessory protective case for a wide variety of portable electronic devices, including but not limited to cellular telephones, personal digital assistants, music players, portable computers, etc. Disclosed embodiments of the device case are characterized by low-profile form factor and inclusion of all components/assemblies needed to provide power and recharge the internal batteries of a portable electronic device from ac mains power, while allowing the device to be manipulated and used during charging.

### Illustrated Embodiments

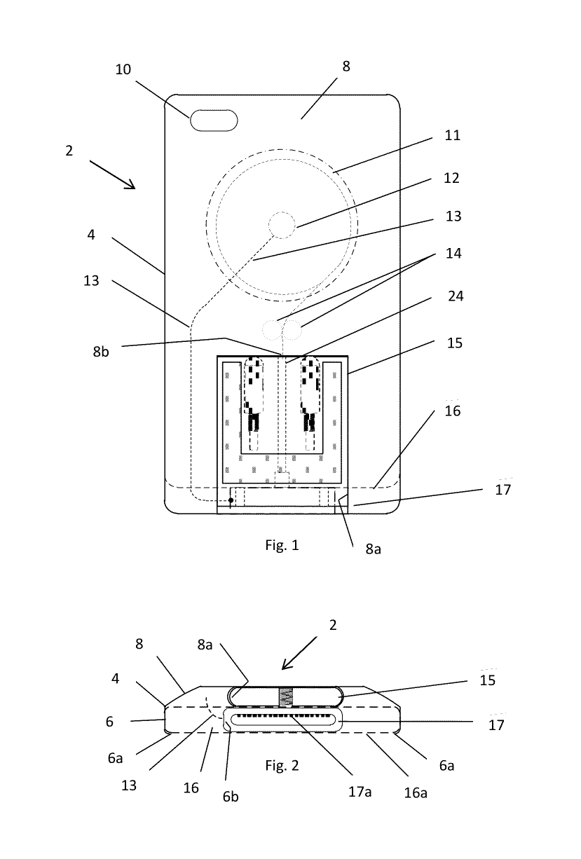

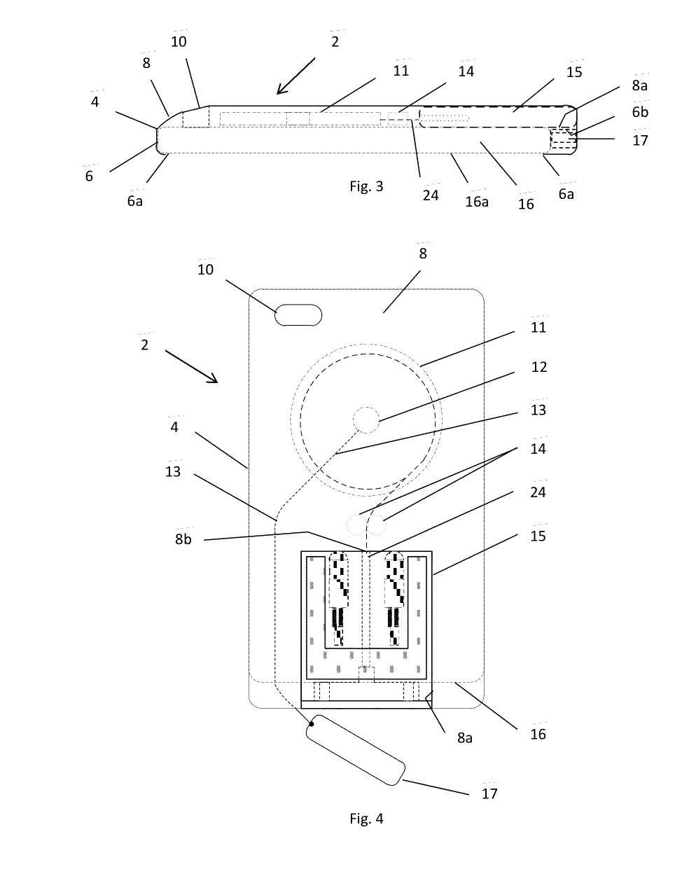

Turning now to the Drawings, wherein like reference numerals signify like elements in all of the several views, FIG. 1 is a plan view of the rear of an accessory protective case 2 when installed on a representative portable electronic device 16, such as a cellular telephone. The case 2 is constructed as a conformal covering shell 4 that can be fabricated from plastic or other resilient material (e.g., polycarbonate or glass-reinforced plastic), by injection molding for example, to form a unique shape that encompasses all or a portion of the portable electronic device 16. The case shell 4 may be constructed of one or more pieces that either flex or snap together in order to allow the portable electronic device 16 to be inserted or removed. With additional reference to FIGS. 2 and 3, the case shell 4 in the illustrated embodiment includes a device compartment 6 and a component compartment 8. The device compartment 6 is configured to receive the portable device 16 in a manner that encompasses the entire periphery of the device. A retaining lip 6A may be provided on the device compartment 6 to captivate a front edge 16a of the portable electronic device 16. Alternatively, the device compartment 6 could be configured to captivate an intermediate edge or other device feature (not shown). As can be seen in FIG. 1, the case shell 4 may include holes or cut-outs, such as shown by reference number 10, for access to device surface features such as cameras, headphone jacks and speakers. These access holes may be on the back or any edge surface of the case shell 4. For example, in FIG. 1, the hole or cutout 10 represents a camera opening formed in the back of the case shell 4. As can be seen in FIG. 3, the hole or cutout 10 extends through the component compartment 8, which may be formed as a generally solid structure having one or more cavities or chambers for carrying the various power conversion and charging components to be described below. The component compartment 8 could also be implemented as a generally hollow structure that includes a rear wall defining the rear surface of the case shell 4, and interior walls or other structures to support the power conversion and charging components. An interior dividing wall may also be provided to define the back of the device compartment 6 and the front of the component compartment 8. It should be noted that the component compartment 8 need not be substantially coextensive with the device compartment 6, as it is in FIGS. 1-3. In an alternate embodiment, the component compartment 8 could be smaller than the device compartment 6, perhaps being just large enough to carry the power conversion and charging components now to be described. In other embodiments, there might be several component compartments that accommodate the various case components.

With continuing reference to FIGS. 1-3, the component compartment 8 houses the power conversion and charging components of the case 2. For example, a captive dc power cord 24 for the case 2 is wound on a reel or spool 11. The power cord reel 11 can be mounted in any suitable manner within the component compartment 8. In an exemplary embodiment, the power cord reel 11 may be flush-mounted in an open cavity formed in the rear face of the component compartment 8, so that it may be manually wound to retract the dc power cord. Alternatively, if the power cord reel 11 is inaccessible within the component compartment 8, or even if it is exposed for manual accessibility as described above, the power cord reel may be equipped with a spring and ratchet mechanism to allow assisted retraction of the dc power cord 24. The power cord reel 11 may be equipped with a multi-circuit electrical slip ring 12 to maintain an electrical connection between an anchored end of dc power cord 24 and an internal circuit 13. As can be seen in FIGS. 1 and 2, the internal circuit 13 carries electrical energy to an interface connector 17 that supplies dc power from the case 2 to the portable electronic device 16. A wiper portion of the slip ring 12 is connected to the internal circuit 13 such that the electrical connection is maintained while allowing the power cord reel 11 to rotate. Near one edge of the component compartment 8, a power converter module 15 is fitted and retained within a module holder 8a when the power converter module not in use. The module holder 8a may be formed in the component compartment 8 in various ways, including as an open channel, recess or other cavity. A power cord access opening 8b is provided in component compartment 8 in order to route the dc power cord 24 between the interior of the component compartment (where the power cord reel 11 is located) and the module holder 8a (where the power conversion module 15 is carried). The component compartment 8 may also be equipped with guide rollers 14 that are spaced from the power cord reel 11. The guide rollers 14 guide the dc power cord 24 on and off the power cord reel 11 as it is extended and retracted to minimize the likelihood of jamming. Alternatively, the guide rollers 14 may be instead be replaced by making the cross-section of the power cord access opening 8b identical to that of the dc power cord 24 in order to minimize mis-alignment and twisting as the power cord is extended and retracted.

FIG. 2 is an elevation view of one end of the case 6 and the portable electronic device 16 showing the narrow ends of the power converter module 15 and the device interface connector 17. When not in use, the power converter module 15 is housed in the module holder 8a, and may be released for separation in any suitable way. For example, the power converter module 15 could be sized to tightly fit within the module holder 8a, and could be removed by simply sliding it out the back of the module holder. Alternatively, a manually operated latch mechanism or the like (not shown) could be used to retain and release the module holder 8a. The interface connector 17 mates with a native dc power connector receptacle (not shown) of the portable electronic device 16 through which battery charging power is supplied. Optionally, the interface connector 17 may be equipped with a receptacle 17a to support an external connection, such as from a headset or USB interface, to the same device connector (pass-through) without un-mating the interface connector. An opening 6b may be formed in the device compartment to allow access to the receptacle 17a. If the receptacle 17a is not provided, un-mating of the interface connector 17, as shown in FIG. 4 will be required in order to allow other external connections to device's native power receptacle.

In FIG. 3 represents an elevation view of the longer dimension of the case 2 and the portable electronic device 16. The reel 11 for the dc power cord 24 is shown, as well as the power converter module 15 and the interface connector 17. In FIG. 4, the rear of the case 2 and portable electronic device 16 is again shown in plan view, but with the interface connector 17 temporarily un-mated from the portable electronic device in order to allow other external devices (e.g. computers) to be connected to the portable electronic device without the need to remove the case. It should be apparent to anyone practiced in the art that the form factor of the interface connector 17, and its location on the case 2, may be selected as necessary to mate with any electrical connector on the portable electronic device 16.

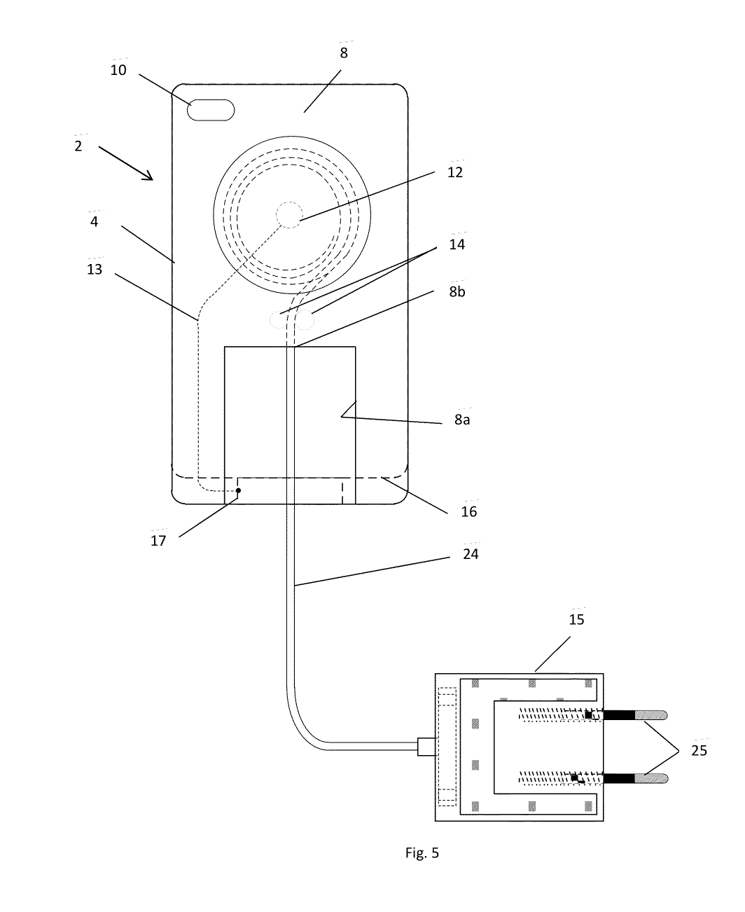

FIG. 5 shows a plan view of the case 2 and portable electronic device 16, with the power converter module 15 deployed. The dc power cord 24 is extended from the power cord reel 11 and captivated to the power converter module 15. A pair of ac mains power plug connectors, implemented as plug blades 25, are shown in an extended and rotated (see below) position required to conform with the NEMA 1-15P plug standard widely used throughout North America. FIG. 6 shows a corresponding end view of the case 2. In this view, the module holder 8a is shown to have a cavity configuration that conforms to the narrow end profile of the power converter module 15. Moreover, the module holder 8a is shown to be an open channel that exposes the rear face of the power converter module 15, allowing a user's thumb to push and slide the module out of the channel for deployment. An example configuration of the power cord access opening 8b is also shown.

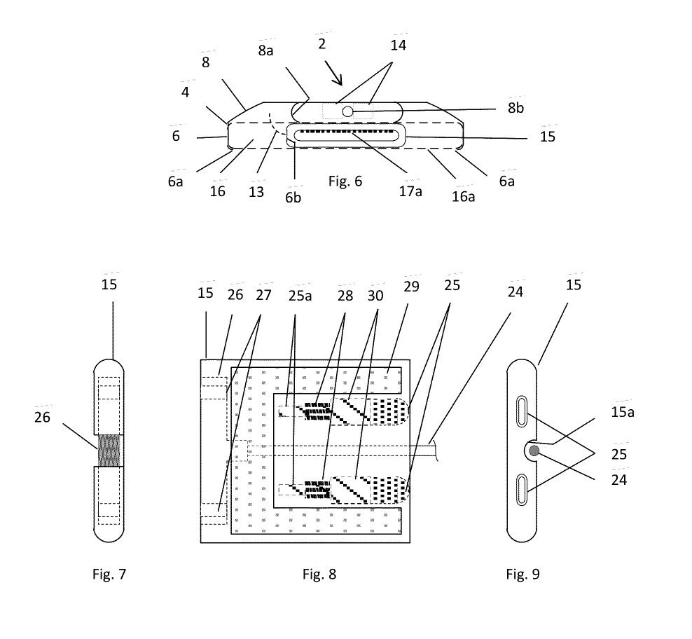

Further details of the power converter module 15 of the case 2 are depicted in FIG. 7 through FIG. 13, and described in the following paragraphs. FIG. 7 is a view of a first narrow end of the power converter module 15 from which the dc power cord 24 exits when deployed. In FIG. 7, a rotatable cord attachment member 26, implemented as a rotating hinge that allows rotation through an angle of at least 180 degrees, is shown rotated to allow the dc power cord 24 to lie flat beneath the power converter module 15 housing in order to minimize storage volume when not in use. In FIG. 8, the cord attachment member 26 is fitted with two electrical slip rings 27 that maintain an electrical connection between the cord attachment member and the power converter's electronic circuitry 29, regardless of the rotational position of the cord attachment member. The ac mains power plug blades 25 are shown in phantom view as they are retracted into the housing envelope of the power converter module 15 for storage. Each plug blade 25 may be flat except for an internal cylindrical portion 25a. Each cylindrical portion 25a mounts a helical spring 28 that forces each blade 25 into an extended position when the power converter module 15 is deployed for use. Each blade 25 is constrained to move only on its longitudinal axis until the flat portion is extended outside the housing envelope of the power converter module 15. Each blade mechanism may also includes a latch (not shown) to hold the helical spring 28 in a compressed state until released by the user for deployment. Alternatively, plug blades 25 may simply extend automatically as the power converter module 15 is removed from the module holder 8a. FIG. 9 is an end view of the second narrow end of the power converter module 15, showing the ac mains power plug blades 25 in the retracted position within the module housing envelope. It should be apparent to those practicing the art that each of the plug blades 25 could easily be replaced by a cylindrical connector pin as is found on an ac mains plug, such as the CEE 7/16 plug standard widely used throughout Europe. FIG. 9 also shows that the housing of the power converter module 15 may be formed with a channel 15a for receiving the dc power cord 24 when the power converter module is in its stowed position.

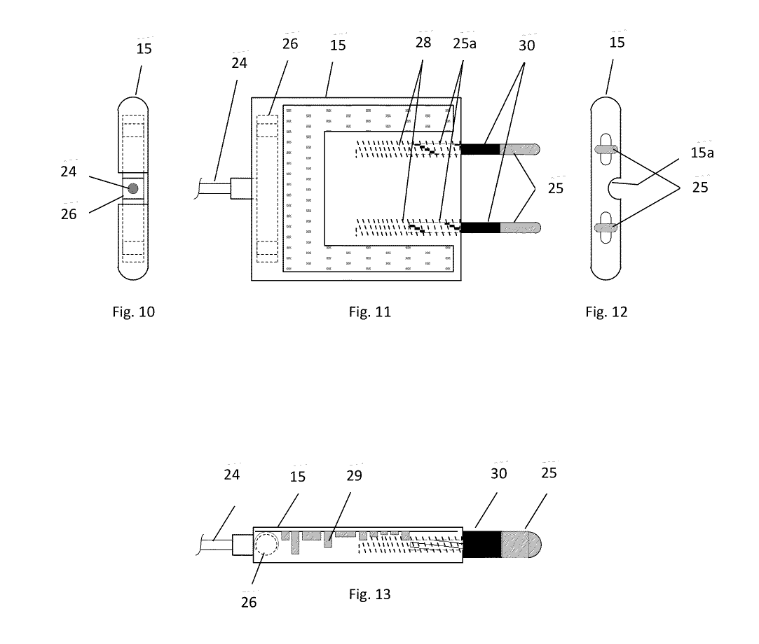

FIG. 10 again depicts a view of the first narrow end of the power converter module 15, but with the dc power cord 24 shown in position for deployment and use. This configuration becomes apparent in FIG. 11, which is a plan view of the power converter module 15 with the dc power cord 24 deployed, and with ac mains power plug blades 25 shown in an extended position for insertion into an ac mains receptacle. In this configuration, the helical springs 28 are in a less-compressed state. Once extended, the blades 25 can be manually rotated 90 degrees each to position them into a standard NEMA 1-15P configuration. Alternatively, instead of manually rotating the blades 25, the internal cylindrical portion 25a of each blade 25 may be fitted with a small pin (not shown) that engages a helical slot (not shown) within the housing envelope of the power converter module 15. The pin-slot engagement provides a cam action that will cause the blade 25 to rotate about its longitudinal axis approximately 90 degrees when the flat portion of the blade 25 extends outside the module housing. A pair of coverings 30 of the ac mains power plug blades 25, shown closest to the housing envelope of the power converter module 15, are preferably fabricated of a non-conductive material in order to prevent inadvertent contact between the plug blades and the user when inserting and removing the power converter module from an ac mains receptacle. Only the tips of the plug blades 25 need to be metallic in order to make electrical contact with the ac mains receptacle. FIG. 12 is a view of the second narrow end of the power converter module with the ac mains power plug blades 25 shown in the extended and rotated position.

Finally, FIG. 13 is an elevation view of the longer side of the power converter module 15 that illustrates further construction details. The dc power cord 24 is shown in the deployed position, as are the ac mains power plug blades 25. The non-metallic covering material 30 of the plug blades 25 is also shown. A diagrammatic representation of electronic components 29 of the power converter module's electronic circuitry are depicted for clarification. The electronic components 29 include ac-to-dc conversion circuitry in order to develop a lower dc voltage for battery charging from a higher ac input voltage. Such circuitry is conventional in nature will not be described further herein.

Accordingly, an auxiliary protective case for a portable electronic device with an integral detachable power converter for battery charging has been disclosed. Although example embodiments have been shown and described, it should be apparent that many variations and alternative embodiments could be implemented in accordance with the present disclosure. It is understood, therefore, that the invention is not to be in any way limited except in accordance with the spirit of the appended claims and their equivalents.

What is claimed is:

1. A protective case for portable electronic devices, comprising:
a conformal covering case shell configured to encompass all or a portion of a portable electronic device;
a detachable power conversion module that implements ac-to-dc conversion circuitry in order to develop a lower dc voltage for powering and recharging said portable electronic device from a higher ac input voltage;
a rotatable power cord reel operable to wind and unwind a captive dc power cord that provides an electrical connection between said power conversion module and an internal circuit of said case shell; and
an interface connector electrically connected to said internal circuit and configured to mate with a receptacle on said portable electronic device in order to deliver dc current for powering and recharging said portable electronic device.

2. A protective case in accordance with claim 1, wherein said power conversion module is fitted and retained in a module holder of said case shell when not in use.

3. A protective case in accordance with claim 2, wherein said power conversion module is detachable by way of being released and removed from said module holder and separated from said case shell while unwinding said captive dc power cord from said power cord reel.

4. A protective case in accordance with claim 1, wherein said power conversion module includes movable electrical power plug connectors that are positionable between an extended position in which said power plug connectors extend outside a housing envelope of said power conversion module and a refracted position in which said power plug connectors are refracted within said housing envelope, said power plug connectors being spring-loaded to bias them toward said extended position.

5. A protective case in accordance with claim 4, wherein said power plug connectors comprise power plug blades conforming to the North American NEMA 1-15P plug standard.

6. A protective case in accordance with claim 5, wherein said power plug blades are rotatable between a first orientation when in said extended position and a second orientation when in said retracted position.

7. A protective case in accordance with claim 1, wherein said power plug connectors comprise cylindrical power plug pins conforming to the European CEE 7/16 plug standard.

8. A protective case in accordance with claim 1, wherein said ac-to-dc conversion circuitry of said power conversion module is operable with input voltages over the range of 110-240 volts ac and input frequencies over the range of 47-63 Hz.

9. A protective case in accordance with claim 1, wherein said captive dc power cord is connected to said power conversion module by way of a rotating hinge means that allows rotation through an angle of at least 180 degrees.

10. A protective case in accordance with claim 9, wherein said rotating hinge includes electrical slip rings to maintain electrical contact with adjacent stationary components of said ac-to-dc conversion circuitry throughout a range of rotation of said hinge.

11. A protective case in accordance with claim 1, wherein said case shell includes a device compartment configured to receive said portable electronic device and containing said interface connector, and a component compartment containing said power conversion module and said power cord reel.

12. A protective case in accordance with claim 11, wherein said component compartment is substantially coextensive with said device compartment.

13. A protective case in accordance with claim 1, wherein said power cord reel includes an electrical slip ring to maintain electrical contact between said dc power cord and said internal circuit throughout a range of rotation of said power cord reel.

14. A protective case in accordance with claim 1, wherein said power cord reel has a face that is exposed on a surface of said case shell so that said power cord reel may be manually rotated by means of finger pressure to extend and retract said dc power cord.

15. A protective case in accordance with claim 1, wherein said power cord reel is equipped with a spring and ratchet mechanism to apply assisting torque to said power cord reel when retracting said dc power cord.

16. A protective case in accordance with claim 1, wherein said case shell is fitted with guide rollers spaced from said power cord reel to guide said dc power cord on to and off of said power cord reel during extension and retraction of said dc power cord.

17. A protective case in accordance with claim 1, wherein said case shell includes a power cord access hole whose cross-section is identical to that of said dc power cord in order to minimize mis-alignment and twisting as said dc power cord during extension and retraction of said dc power cord.

18. A protective case in accordance with claim 1, wherein said interface connector includes both a plug or male connector to mate with said receptacle on said portable electronic device and a jack or female connector to allow connection of external devices without un-mating of said interface connector from said portable electronic device.

19. In combination, a protective case and a portable electronic device, said combination comprising:
a portable electronic device;
a conformal covering case shell encompassing all or a portion of said portable electronic device;
a detachable power conversion module that implements ac-to-dc conversion circuitry in order to develop a lower dc voltage for powering and recharging said portable electronic device from a higher ac input voltage;
a rotatable power cord reel operable to wind and unwind a captive dc power cord that provides an electrical connection between said power conversion module and an internal circuit of said case shell; and
an interface connector electrically connected to said internal circuit and mated with a receptacle on said portable electronic device in order to deliver dc current for powering and recharging said portable electronic device.

20. A protective case for portable electronic devices, comprising:
a conformal covering case shell configured to encompass all or a portion of a portable electronic device;
a detachable power conversion module that implements ac-to-dc conversion circuitry in order to develop a lower dc voltage for powering and recharging said portable electronic device from a higher ac input voltage;
a rotatable power cord reel operable to wind and unwind a captive dc power cord that provides an electrical connection between said power conversion module and an internal circuit of said case shell;
an interface connector electrically connected to said internal circuit and configured to mate with a receptacle on said portable electronic device in order to deliver dc current for powering and recharging said portable electronic device'
said power conversion module being fitted and retained in a module holder of said case shell when not in use;
said power conversion module being detachable by way of being releasable and removable from said module holder and separated from said case shell while unwinding said captive dc power cord from said power cord reel;
said power conversion module including movable electrical power plug connectors that are positionable between an extended position in which said power plug connectors extend from a housing envelope of said power conversion module and a retracted position in which said power plug connectors are retracted within said housing envelope;
said power plug connectors comprising power plug blades conforming to the North American NEMA 1-15P plug standard or cylindrical power plug pins conforming to the European CEE 7/16 plug standard;
if said power plug connectors comprise power plug blades, said power plug blades are rotatable between a first orientation when in said extended position and a second orientation when in said retracted position;
said ac-to-dc conversion circuitry of said power conversion module being operable with input voltages over the range of 110-240 volts ac and input frequencies over the range of 47-63 Hz;
said captive dc power cord being connected to said power conversion module by way of a rotating hinge means that allows rotation through an angle of at least 180 degrees;
said rotating hinge including electrical slip rings to maintain electrical contact with adjacent stationary components of said ac-to-dc conversion circuitry throughout a range of rotation of said hinge;
said case shell including a device compartment configured to receive said portable electronic device and containing said interface connector, and a component compartment containing said power conversion module and said power cord reel;
said component compartment being substantially coextensive with said device compartment;
said power cord reel including an electrical slip ring to maintain electrical contact between said dc power cord and said internal circuit throughout a range of rotation of said power cord reel;
said power cord reel having one or both of (1) a face that is exposed on a surface of said case shell so that said power cord reel may be manually rotated by means of finger pressure to extend and retract said dc power cord, or (2) a spring and ratchet mechanism to apply assisting torque to said power cord reel when retracting said dc power cord;
said case shell being fitted with guide rollers spaced from said power cord reel to guide said dc power cord on to and off of said power cord reel during extension and retraction of said dc power cord; and
said interface connector including both a plug or male connector to mate with said receptacle on said portable electronic device and a jack or female connector to allow connection of external devices without un-mating of said interface connector from said portable electronic device.
